(19) United States
(12) Patent Application Publication
(10) Pub. No.: US 2006/0090383 A1
(43) Pub. Date: May 4, 2006

(54) Child's strip viewer and method of use thereof

(76) Inventor: Heidi Conner, Escondido, CA (US)

Correspondence Address: Karl M. Steins;Steins & Associates, Suite 120, 2333 Camino del Rio South, San Diego, CA, 92108, US

(21) Appl. No.: 10/980,947

(22) Filed: Nov. 3, 2004

(51) Int. Cl. G09F 11/18

(52) U.S. Cl. 40/518

(57) ABSTRACT

A Child's Strip Viewer and Method of Use Thereof is disclosed. The device enables a child user to compose and record a visual “story board” onto a media strip. The media strip is preformatted to provide a variety of frames into which the child user can record their story. Once recorded, the child user is able to advance the media strip while telling their story verbally, thereby providing an entertaining audio and visual story telling.

### BACKGROUND OF THE INVENTION

1. Field of the Invention

This invention relates generally to children's toys and devices and, more specifically, to a Child's Strip Viewer and Method of Use Thereof.

2. Description of Related Art

There is a virtually limitless variety of entertainment- and entertainment-oriented games and playthings. In particular, there are several items that encourage the child to draw pictures and story-tell. Three patents on devices related to the present invention are Cohen, U.S. Pat. No. 5,556,339; Cohen, U.S. Pat. No. 5,746,604; and Yeh, U.S. Pat. No. 6,567,076. All of these devices take a high-technology approach to entertaining the child in a story-telling environment. What is needed is a low-tech approach to entertaining the child in this manner.

### SUMMARY OF THE INVENTION

In light of the aforementioned problems associated with the prior games and devices, it is an object of the present invention to provide a Child's Strip Viewer and Method of Use Thereof. The device should enable a child user to compose and record a visual “story board” onto a media strip. The media strip should be preformatted to provide a variety of frames into which the child user could record their story. Once recorded, the child user should be able to advance the media strip while telling their story verbally, thereby providing an entertaining audio and visual story telling.

### BRIEF DESCRIPTION OF THE DRAWINGS

The objects and features of the present invention, which are believed to be novel, are set forth with particularity in the appended claims. The present invention, both as to its organization and manner of operation, together with further objects and advantages, may best be understood by reference to the following description, taken in connection with the accompanying drawings, of which:

FIG. 1 is a rear perspective view of a preferred embodiment of the strip viewer of the present invention;

FIG. 2 is another rear perspective view of the strip viewer of FIG. 1;

FIG. 3 is a perspective view of a preferred embodiment of the media spool used in the strip viewer of the present invention;

FIG. 4 is another perspective view of the media spool of FIG. 3;

FIG. 5 is a partial cutaway front view of the strip of FIGS. 3 and 4;

FIG. 6 is a flowchart depicting a preferred story-telling method using the strip viewer of the present invention; and

FIG. 7 is a perspective view of another embodiment of the strip viewer of the present invention.

### DETAILED DESCRIPTION OF THE PREFERRED EMBODIMENTS

The following description is provided to enable any person skilled in the art to make and use the invention and sets forth the best modes contemplated by the inventor of carrying out her invention. Various modifications, however, will remain readily apparent to those skilled in the art, since the generic principles of the present invention have been defined herein specifically to provide a Child's Strip Viewer and Method of Use Thereof.

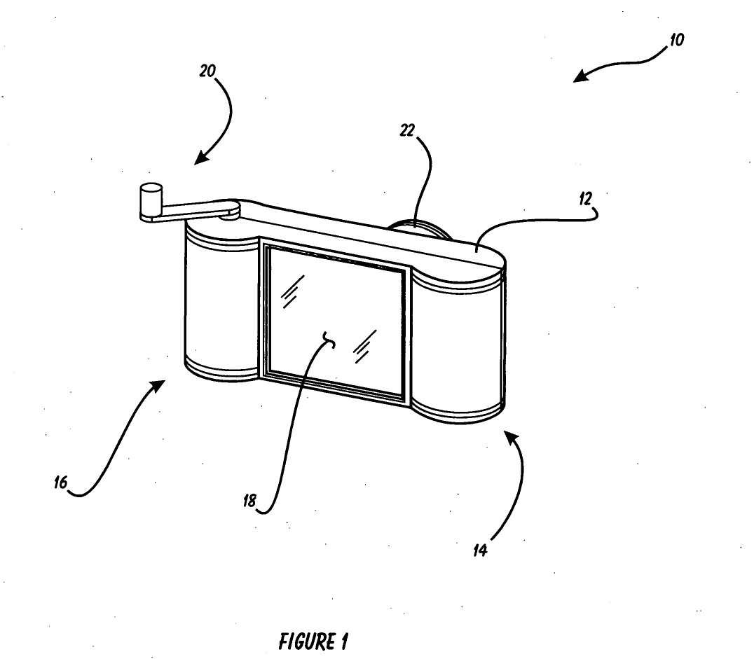

The present invention can best be understood by initial consideration of FIG. 1. FIG. 1 is a rear perspective view of a preferred embodiment of the strip viewer 10 of the present invention. The viewer 10 depicted here resembles the shape of a photographic camera. It comprises a body 12 (shaped like a camera) having a lens-shaped protrusion 22 on its rear face. The body 12 is defined by a first spool chamber 14 and a second spool chamber 16 at opposing sides of the device. Between the two chambers 14 and 16 is a translucent and/or transparent window 18. Protruding from the top (or bottom on other embodiments) of the second spool chamber 16 is a crank 20. Ideally, some or all of the components of the strip viewer 10 will be made from a durable material, such as plastic.

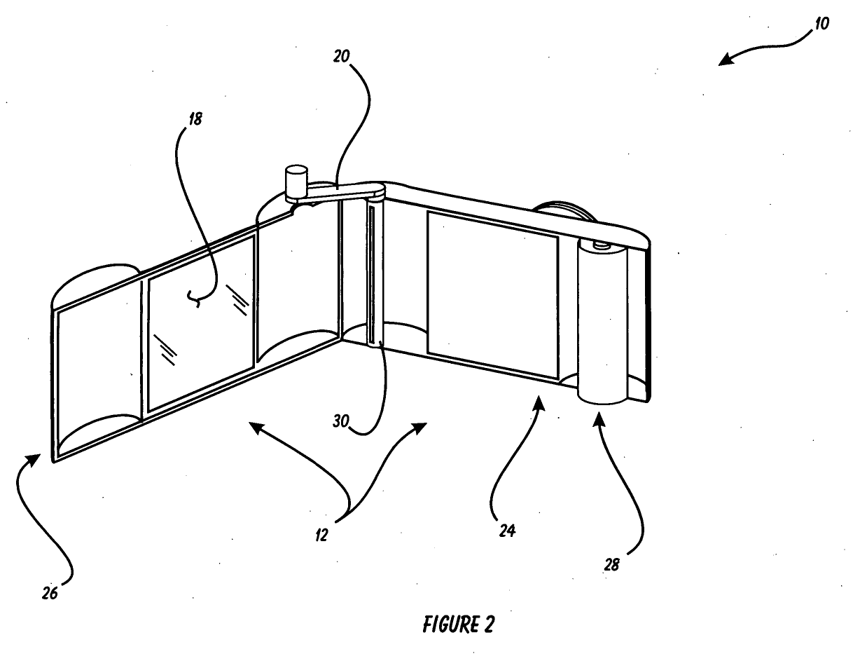

In another non-depicted version, the functionality of the crank 20 (i.e. to advance the strip) is accomplished by a motorized crank means. Furthermore, the device may incorporate other capabilities within it, such as an electronic voice recorder. As such, the depicted “low technology” version of the device is not intended to be a limitation of the device. Now turning to FIG. 2, we can continue to discuss the features of this novel device.

FIG. 2 is another rear perspective view of the strip viewer 10 of FIG. 1. In this view, the body 12 has been opened to expose the pertinent inner moving parts of the viewer 10. The body 12 is divided into a back member 24 (from which the lens-shaped protrusion protrudes) and a cover 26. The cover 26 preferably is hinged to the back member 24, and latches securely when closed as depicted in FIG. 1.

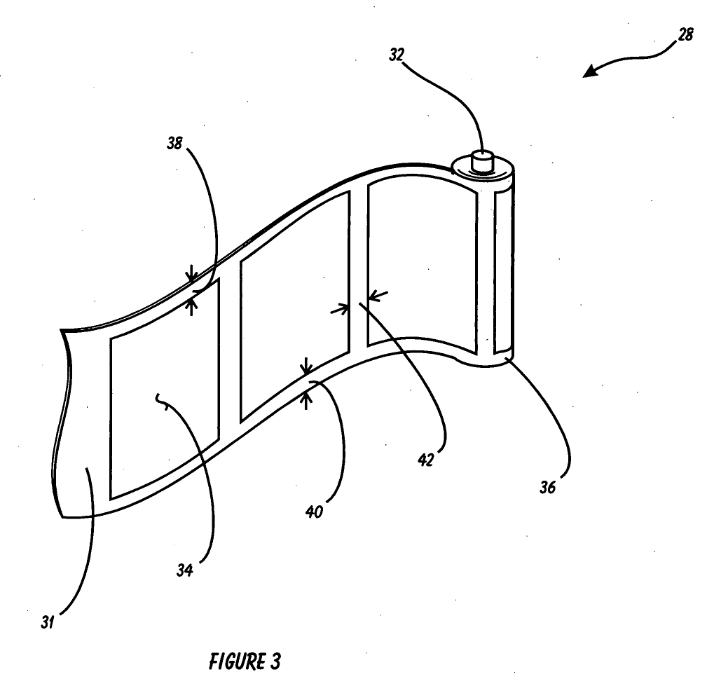

Within the first and second spool chambers are a media spool 28 (within the first spool chamber) and a take-up spindle 30. The crank 20 is operatively attached to the take-up spindle 30 such that rotation of the crank 20 causes the take-up spindle 30 to also rotate. It should be apparent that the purpose of the arrangement of these elements is that the rolled up media that comprises a media spool 28 will be threaded through a slot in the take-up spindle 30; rotation of the crank 20, therefore, will cause the media strip to roll up on the spindle 30 (and unroll from the media spool 28). As this occurs, the media strip will be viewable through the window 18. We will now turn to FIG. 3 and continue to examine this invention.

FIG. 3 is a perspective view of a preferred embodiment of the media spool 28 used in the strip viewer of the present invention. The spool 28 is made from a thin, flexible substrate 31 strip, such as paper or plastic. The front and possibly back face of the substrate 31 has a plurality of frame borders 36 inscribed upon it. The substrate 31 is rolled up and retained upon a spindle 32; as should be apparent, the spindle 32 attaches to the body of the viewer but permits the spool 28 to rotate while the substrate 31 is rolled onto and unrolled from the spindle 32.

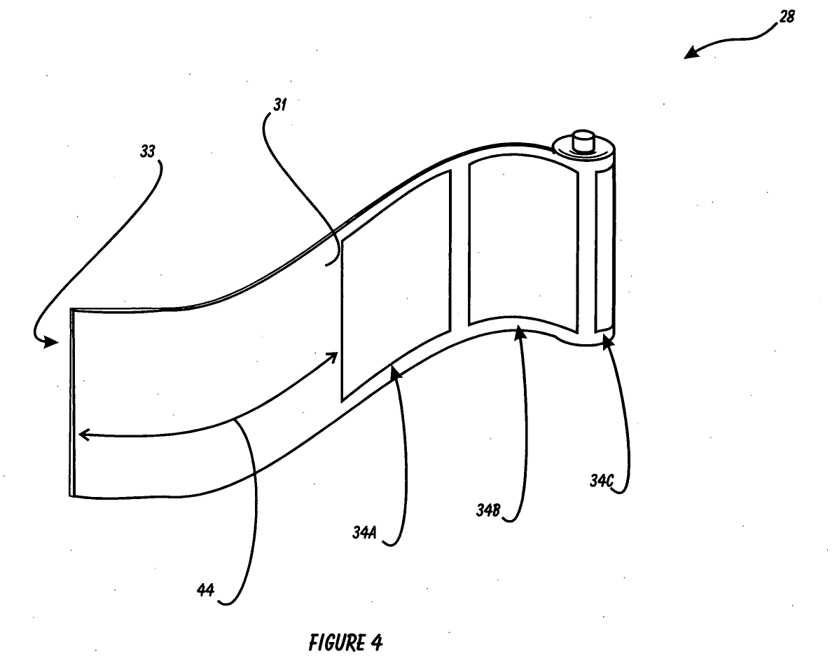

The substrate 31 has an inscription frame 34 inscribed near the starting end of the substrate 31 strip. Each of the frames formed by the frame borders 36 is separated from one another by intra-border spacing 42, and from the upper and lower edges of the substrate by a top border spacing 38 and bottom border spacing 40, respectively. FIG. 4 provides additional detail regarding the media spool 28.

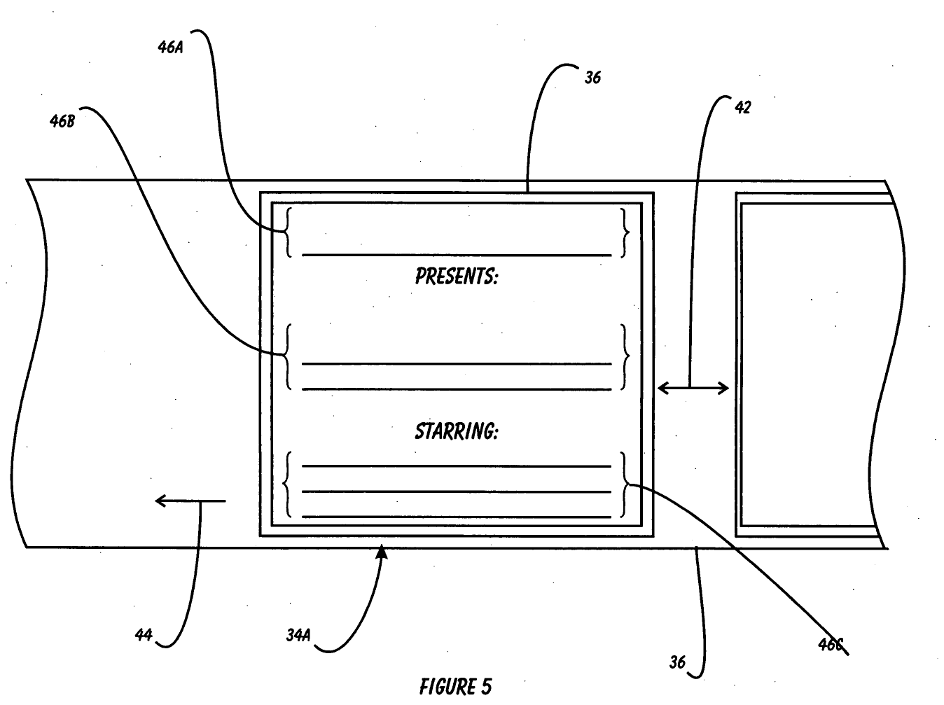

FIG. 4 is another perspective view of the media spool 28 of FIG. 3. The substrate 31 inscriptions commence with the credits frame 34A; a series of content frames 34B, 34C, etc. follow the credits frame 34A. This pattern may repeat further down the spool 28 so that the user can tear off a used portion and have a new section of story-telling substrate 31 available for use. The credits frame 34A is separated from the lead end 33 of this story-telling section by a leader segment 44. The leader segment 44 is a blank section of substrate 31 that is provided to give the user enough material to thread the substrate 31 through the take-up spool and still allow the credits frame 34A to be alignable with the window. Well now turn to FIG. 5 to study the story-telling strip of the present invention in detail.

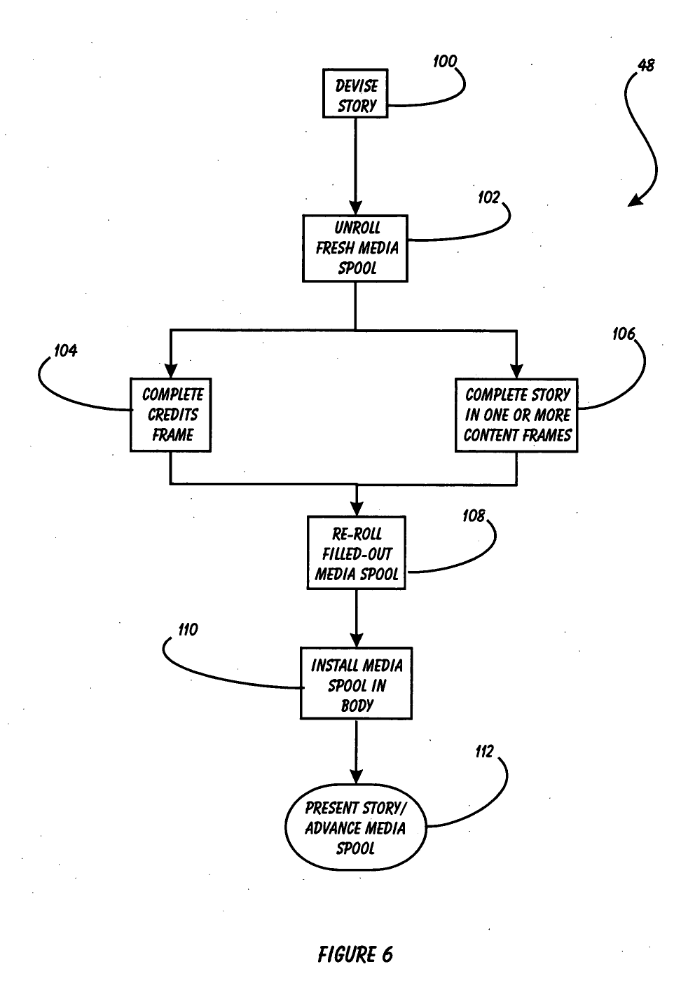

FIG. 5 is a partial cutaway front view of the strip of FIGS. 3 and 4. The credits frame 34A comprises a decorative border 36 surrounding a plurality of pre-established fields or zones inscribed on the substrate 31. Near the top of the credits frame 34A is the author field 46A; it is here that the child or parent would write in the author's name. Below the author field 46A is a title field 46B. The title field is provided for the child/parent to inscribe the title of the story that the child is telling with this story-telling strip. Next, a cast field 46C is provided to list the characters that are going to be depicted in the frames 34 following the credits frame 34A. The remaining frames 34 are provided for the child to draw or sketch out the scenes in the story that he or she will be telling with the viewer. FIG. 6 discusses the approach that the child will take in competing the story.

FIG. 6 is a flowchart depicting a preferred story-telling method 48 using the strip viewer of the present invention. First, the author devises the story to be told 100. Next, a fresh portion of the media is unrolled from the spool 102. The child will then complete the credits frame 104 as well as coloring/sketching the story within as many content frames are desired 106.

Once the story has been depicted in the content and credits frames, the child or parent re-rolls the media onto the media spool 108. The rolled up media spool is then installed in the body 110 (including threading the leading end through the take-up spindle). Finally, the child present his or her story by turning the crank on the viewer, manually narrating, and viewing the completed frames though the windows 112.

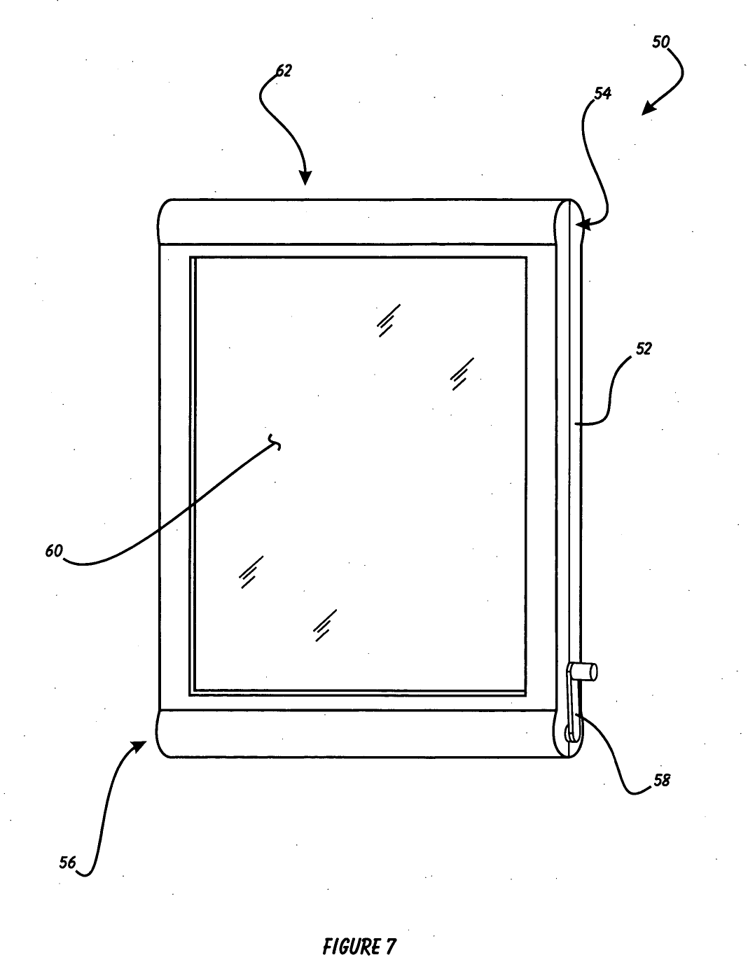

There are several significant benefits and advantages associated with this unique invention. Foremost, it provides children with an exciting outlet that effectively fosters their creativity and imagination. It offers a way to create, narrate, and project their own film, thereby stimulating the mind and honing the thought processes. In addition, drawing coupled with intricate narrative weaves via colorful and whimsical illustrations helps to sharpen hand-eye coordination. Furthermore, while this device and method is ideal for children, parents and other caregivers also enjoy the interaction, thereby promoting improved parent-child interaction. Finally turning to FIG. 7, we can examine another version of the present invention.

FIG. 7 is a perspective view of another embodiment of the strip viewer 50 of the present invention. This embodiment 50 is intended to closely simulate a writing tablet; as such, it may be larger than the previously-disclosed viewer. Here, the first spool chamber 54 is at the top of the body 52, and the second spool chamber 58 is at the bottom of the body 52. The window 60 is located in the area between the two spool chambers. The back member and cover are attached to one another by a hinge 62. As with the first-described embodiment, this version has a crank 58 extending from the second spool chamber 56.

In another version of this embodiment, the spool chambers could be located on the left and right sides of the body 52, rather than at the top and bottom.

Those skilled in the art will appreciate that various adaptations and modifications of the just-described preferred embodiment can be configured without departing from the scope and spirit of the invention. Therefore, it is to be understood that, within the scope of the appended claims, the invention may be practiced other than as specifically described herein.

What is claimed is:

1. A child's strip viewer combination, comprising:
a strip viewer comprising a body having a first spool chamber and a second spool chamber, said second spool chamber comprising a takeup spindle housed therein, with a crank attached thereto and a translucent window disposed between said first and second spool chambers; and
a media spool inserted within said first spool chamber.

2. The combination of claim 1, wherein said takeup spindle comprises an elongate member substantially housed within said second spool chamber but defined by a first end extending through a aperture formed in said second spool chamber.

3. The combination of claim 2, wherein said crank extends from said first end of said takeup spindle.

4. The combination of claim 3, wherein said takeup spool comprises:
a media spindle; and
a media strip wrapped around said media spindle.

5. The combination of claim 4, wherein said media strip comprises:
a substrate defined by a lead end, a front surface, a back surface, a top edge and a bottom edge;
a credits frame inscribed on said front surface; and
a plurality of content frames inscribed on said front surface.

6. The combination of claim 5, wherein said credits and content frames are inscribed in spaced relation along said front surface, said frames separated by intra-border spacing.

7. The combination of claim 6, wherein said content and credit frames are separated from said top and bottom edges of said substrate by top border spacing and bottom border spacing, respectively.

8. The combination of claim 7, wherein said body is defined by a back member and a cover, said back member hingeably attached to said cover.

9. The combination of claim 8, wherein said cover is defined by said window.

10. A child's strip viewer, comprising:
a body having a first spool chamber and a second spool chamber, said second spool chamber comprising a takeup spindle housed therein, with a cranking means attached thereto and a translucent window disposed between said first and second spool chambers.

11. The viewer of claim 10, wherein said cranking means comprises a crank member.

12. The viewer of claim 11, wherein said takeup spindle comprises an elongate member substantially housed within said second spool chamber but defined by a first end extending through a aperture formed in said second spool chamber.

13. The viewer of claim 12, wherein said crank extends from said first end of said takeup spindle.

14. The viewer of claim 13, wherein said takeup spool comprises an elongate media spindle.

15. The viewer of claim 10, wherein said takeup spindle comprises an elongate member substantially housed within said second spool chamber but defined by a first end extending through a aperture formed in said second spool chamber.

16. The viewer of claim 15, wherein said crank extends from said first end of said takeup spindle.

17. The viewer of claim 16, wherein said takeup spool comprises an elongate media spindle.

18. The viewer of claim 17, wherein said body is defined by a back member and a cover, said back member hingeably attached to said cover.

19. The viewer of claim 18, wherein said cover is defined by said window.

20. A story telling method, comprising the steps of:
devising a story to be told;
unrolling a media spool, said media spool comprising a substrate defined by a lead end, a front surface, a back surface, a top edge and a bottom edge, a credits frame inscribed on said front surface, and a plurality of content frames inscribed on said front surface;
filling said credits and content frames with credits and content;
re-rolling said media spool;
installing said media spool with a viewer comprising a body having a first spool chamber and a second spool chamber, said second spool chamber comprising a takeup spindle housed therein, with a crank attached thereto and a translucent window disposed between said first and second spool chambers; and
presenting said story while unrolling said media spool via operation of said crank and while viewing said filled in credits and contents frames through said window.
